(19) United States
(12) Patent Application Publication
(10) Pub. No.: US 2026/0061861 A1
(43) Pub. Date: Mar. 5, 2026

(54) PROTECTIVE STRUCTURE FOR HIGH-VOLTAGE MODULE

(71) Applicant: TOYOTA JIDOSHA KABUSHIKI KAISHA, Toyota-shi (JP)

(72) Inventor: Kazuaki NAKAYAMA, Nagakute-shi (JP)

(73) Assignee: TOYOTA JIDOSHA KABUSHIKI KAISHA, Toyota-shi (JP)

(21) Appl. No.: 19/174,038

(22) Filed: Apr. 9, 2025

(30) Foreign Application Priority Data
Sep. 3, 2024 (JP) 2024-151152

(51) Int. Cl. B60L 50/64; B60K 17/16; B60L 50/60; H01M 50/24; H01M 50/249

(52) U.S. Cl. CPC B60L 50/64; B60K 17/16; B60L 50/66; H01M 50/24; H01M 50/249; H01M 2220/20

(57) ABSTRACT

In a protective structure for a high-voltage module configured to convert electric power that is transferred between a motor serving as a driving force source and a power supply, the high-voltage module is housed in a case. The case includes side walls located on both sides of the case in the vehicle width direction and a front wall located on the front side of the case in the direction of travel of the vehicle. The front wall includes a middle portion that is a middle portion of the front wall in the vehicle width direction and connecting portions located at both ends of the front wall in the vehicle width direction. The connecting portions are located rearward of the middle portion. The protective structure includes a bracket disposed at a predetermined distance forward of the middle portion. Both ends of the bracket are connected to the connecting portions.

### CROSS-REFERENCE TO RELATED APPLICATION

This application claims priority to Japanese Patent Application No. 2024-151152 filed on Sep. 3, 2024. The disclosure of the above-identified application, including the specification, drawings, and claims, is incorporated by reference herein in its entirety.

### BACKGROUND

### 1. Technical Field

The present disclosure relates to structures for protecting a high-voltage module that connects a power supply mounted on a vehicle and a motor serving as a driving force source.

### 2. Description of Related Art

Japanese Unexamined Patent Application Publication No. 2012-139012 (JP 2012-139012 A) describes a power converter connected to an alternating current motor serving as a driving force source for a hybrid electric vehicle and a direct current power supply. This power converter is provided with an inverter circuit. The inverter circuit is configured to convert direct current power output from a direct current power supply to alternating current power to output the alternating current power to an alternating current motor, and is also configured to convert alternating current power generated by the alternating current motor to direct current power to output the direct current power to the direct current power supply. This power converter is provided with a capacitor module etc. configured to smooth direct current power to be supplied to the inverter circuit.

### SUMMARY

Like the alternating current motor described in JP 2012-139012 A, the output torque of a motor provided as a driving force source for a vehicle can be increased by increasing the electric power supplied to the motor. In other words, a higher voltage is applied to a power converter when the output of the motor is to be increased in order to increase a travel region in which the vehicle runs on the motor so as to reduce the engine load or in order to increase the maximum torque of the vehicle. In the case of a vehicle using only a motor as its driving force source such as an electrified vehicle, a higher voltage is applied to a power converter when the maximum torque of the vehicle is to be increased. Therefore, the size of a power converter is increased in order to reduce its electrical resistance or to improve its durability.

When a large power converter is used, the power converter may protrude forward beyond an engine, a power transmission device, etc. in the direction of travel of a vehicle. In such a case, since a member that receives an impact load from the outside is not present forward of the power converter in the direction of travel of the vehicle, a large impact load may act on the power converter including a case housing an inverter, a capacitor, etc. in the event of a collision of the vehicle. Moreover, the use of a large power converter limits the space for mounting an energy absorbing member that receives an impact load from the outside, which may make it difficult to mount the energy absorbing member.

The present disclosure was made in view of the above technical issue, and an object of the present disclosure is to provide a protective structure for a high-voltage module that can improve the capability to protect the high-voltage module in the event of a collision of a vehicle.

In order to achieve the above object, the present disclosure provides a protective structure for a high-voltage module configured to convert electric power that is transferred between a motor serving as a driving force source for a vehicle and a power supply for the motor.
The high-voltage module is housed in a case. The case includes side walls located on both sides of the case in a vehicle width direction and a front wall located on the front side of the case in a direction of travel of the vehicle.
The front wall includes a middle portion that is a middle portion of the front wall in the vehicle width direction, and connecting portions located at both ends of the front wall in the vehicle width direction.
The connecting portion is located rearward of the middle portion in the direction of travel of the vehicle.
The protective structure includes a bracket disposed at a predetermined distance forward of the middle portion in the direction of travel of the vehicle. Both ends of the bracket in the vehicle width direction are connected to the connecting portions.

In the present disclosure, the connecting portion may be a tilted surface that extends gradually rearward in the direction of travel of the vehicle from the middle portion toward outside in the vehicle width direction.

In the present disclosure, the high-voltage module may be provided in a front compartment of the vehicle.

In the present disclosure, the bracket may have the same height in a vehicle height direction as the case.

In the present disclosure, the protective structure may further include a transaxle case that houses a power transmission device configured to transmit torque from the motor to a drive wheel.
The front wall may be located forward of a front end of the transaxle case in the direction of travel of the vehicle.

According to the present disclosure, the bracket is provided at the predetermined distance forward of the case housing the high-voltage module in the direction of travel of the vehicle. Therefore, when the vehicle collides with an obstacle etc. ahead, the bracket receives an impact load. The impact load acting on the bracket is transmitted to the connecting portions at both ends of the case via both ends of the bracket. Accordingly, the load applied to the case can be received by the connecting portions having relatively high rigidity against the impact load. This can reduce the load acting on the middle portion of the front wall of the case, and therefore, can reduce damage to the high-voltage module due to deformation of the front wall of the case, and exposure of the high-voltage module due to damage to the case etc. In other words, it is possible to improve the capability to protect the case in the event of a collision of the vehicle.

The connecting portions are located rearward of the middle portion in the direction of travel of the vehicle. This provides a sufficient space for mounting the bracket, and also the clearance between the bracket and the front wall of the case is less likely to become excessively large. In other words, the bracket for protecting the case can be mounted even when the clearance is small between the case and a member etc. disposed forward of the case in the direction of travel of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A schematically shows an example of an electrified vehicle equipped with a high-voltage module according to an embodiment of the present disclosure, showing a top view of a front compartment of the electrified vehicle;

FIG. 1B schematically shows an example of the electrified vehicle equipped with the high-voltage module according to the embodiment of the present disclosure, showing a side view of the front compartment;

FIG. 2A is an enlarged view schematically showing a PCU case, showing a top view of the PCU case; and

FIG. 2B is an enlarged view schematically showing the PCU case, showing a side view of the PCU case.

### DETAILED DESCRIPTION OF EMBODIMENTS

The present disclosure will be described based on an embodiment shown in the drawings. Note that the embodiments described below are merely examples of a case where the present disclosure is embodied, and the present disclosure is not limited thereto.

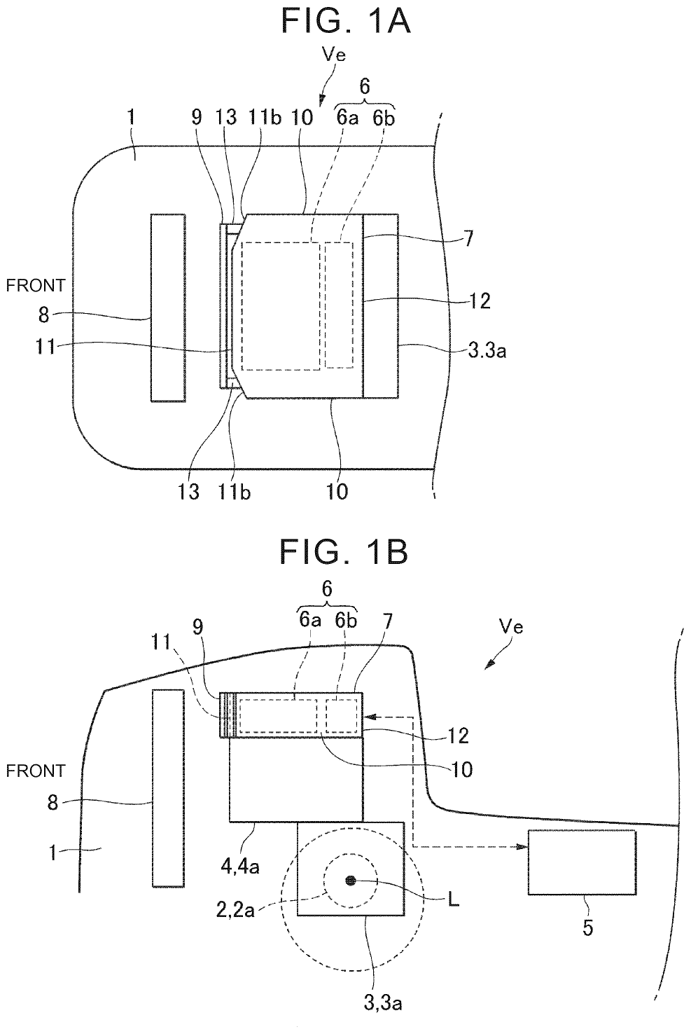

An example of an electrified vehicle equipped with a high-voltage module according to an embodiment of the present disclosure is schematically shown in FIGS. 1A and 1B. FIG. 1A is a top view of a front compartment 1 of an electrified vehicle (hereinafter simply referred to as a vehicle) Ve, and FIG. 1B is a side view of the front compartment 1.

The vehicle Ve shown in FIGS. 1A and 1B includes a motor 2 as a driving force source. The motor 2 is constituted by an alternating current motor such as a synchronous motor or an induction motor. This is similar to a motor provided as a driving force source such as a conventional hybrid electric vehicle or battery electric vehicle. That is, in addition to the function as a motor that generates a driving torque by supplying alternating current power, the output shaft is provided with a function as a generator that converts the power into electric power by being rotated together.

The motor 2 is provided with a power transmission device 3 such as a speed reduction mechanism for amplifying the torque of the motor 2 and a differential mechanism for dividing the torque of the motor and transmitting the divided torque to the right and left drive wheels, and one end of the drive shaft is connected to the power transmission device 3. That is, the power transmission device 3 is provided such that the rotation center axis L of the output member of the power transmission device 3 and the rotation center axis of the drive shaft coincide with each other.

In the vehicle Ve shown in FIGS. 1A and 1B, the motor 2 and the power transmission device 3 are arranged side by side in the vehicle width direction such that the rotation center axis of the motor 2 and the rotation center axis L of the output member of the power transmission device 3 coincide with each other. Specifically, the motor case 2a that houses the motor 2 and the transaxle case 3a that houses the power transmission device 3 are arranged side by side in the vehicle width direction, and the cases 2a, 3a are connected by bolts etc. Note that the configuration and arrangement of the motor 2 and the power transmission device 3 may be appropriately changed, for example, in which the rotation center axis of the motor 2 and the rotation center axis L of the output member constituting the power transmission device 3 are arranged side by side in parallel.

The vehicle Ve shown in FIGS. 1A and 1B includes a fuel cell stack 4 functioning as a power supply for the motor 2 and an energy storage device 5. The fuel cell stack 4 can be configured similarly to a fuel cell stack provided in a conventional fuel cell electric vehicle. That is, the fuel cell stack includes a plurality of fuel cells configured to generate direct current power by a chemical reaction between hydrogen supplied from a hydrogen tank, not shown, and oxygen contained in outside air introduced via an air cleaner, not shown, etc. The fuel cells are connected in series and housed in an FC case 4a. The FC case 4a is fixed to a rigid member, not shown, constituting the vehicle body by bolts or the like. The front end face of the FC case 4a in the vehicle is located forward of the front end face of the transaxle case 3a in the vehicle.

The energy storage device 5 is constituted by a lithium-ion battery, a capacitor, or the like in the same manner as an energy storage device provided in a conventional hybrid electric vehicle, a battery electric vehicle, or the like. That is, the energy storage device 5 is configured to output direct current power and charge power by being supplied with direct current power. Although the energy storage device 5 is shown at the lower end of the front side of the cabin in FIGS. 1A and 1B for convenience, the position at which the energy storage device 5 is mounted is not particularly limited.

A power conversion unit 6 corresponding to the “high-voltage module” in the embodiment of the present disclosure is provided on the upper portion of FC case 4a described above. The power conversion unit 6 includes an inverter 6a, a driver circuit 6b, and the like. The inverter 6a converts the direct current power output from the fuel cell stack 4 or the energy storage device 5 into alternating current power and outputs the alternating current power to the motor 2, and also converts the alternating current power generated by the motor 2 into direct current power and outputs the direct current power to the energy storage device 5. The driver circuit 6b outputs drive pulses to switching elements, not shown, constituting the inverter 6a. The inverter 6a and the driver circuit 6b are housed in the PCU case 7 corresponding to the “case” in the embodiment. The PCU case 7 is fixed to the upper portion of the FC case 4a by bolts or the like. The front end faces of the PCU case 7 and the FC case 4a in the vehicle Ve are arranged so as to be substantially flush with each other. That is, the front end face of the PCU case 7 in the vehicle is disposed so as to protrude from the end face of the transaxle case 3a on the vehicle front side.

The motor 2, the power transmission device 3, the fuel cell stack 4, the power conversion unit 6, and an intercooler, not shown, that cools the air supplied to the fuel cell stack 4 shown in FIGS. 1A and 1B are configured to cool by flowing coolant. A radiator 8 for dissipating the heat of the coolant is provided in the front part of the front compartment 1. The radiator 8 is fixed to a front cross member, not shown, or a radiator core support, not shown, similarly to a radiator provided in a conventional vehicle. The front cross member is disposed so as to extend between the front ends of the right and left side members. The radiator core support is disposed so as to extend between the front ends of the right and left front insides, not shown. That is, the radiator 8 is disposed forward of the FC case 4a, the PCU case 7, etc. in the vehicle Ve.

The above vehicle Ve supplies electric power from the energy storage device 5 to the motor 2 during traveling under low load such as during starting or while a requested driving force is small. The above vehicle Ve supplies electric power from the fuel cell stack 4 to the motor 2 during steady running. The above vehicle Ve supplies electric power from the fuel cell stack 4 and the energy storage device 5 to the motor 2 during traveling under high load such as while the requested driving force is large. During braking, the energy storage device 5 is charged with the electric power generated by the motor 2. While the vehicle is stopped, the energy storage device 5 is charged with the electric power generated by the fuel cell stack 4.

Such transfer of electric power between the fuel cell stack 4, the energy storage device 5, and the motor 2 and supply of electric power from the fuel cell stack 4 to the energy storage device 5 are performed via the power conversion unit 6. Therefore, power that can satisfy the traveling power requested for the vehicle Ve flows through the power conversion unit 6. Therefore, the PCU case 7 is integrally provided with the bracket 9 provided at a distance from the front end face of the PCU case 7 in the vehicle Ve and extending in the vehicle width direction.

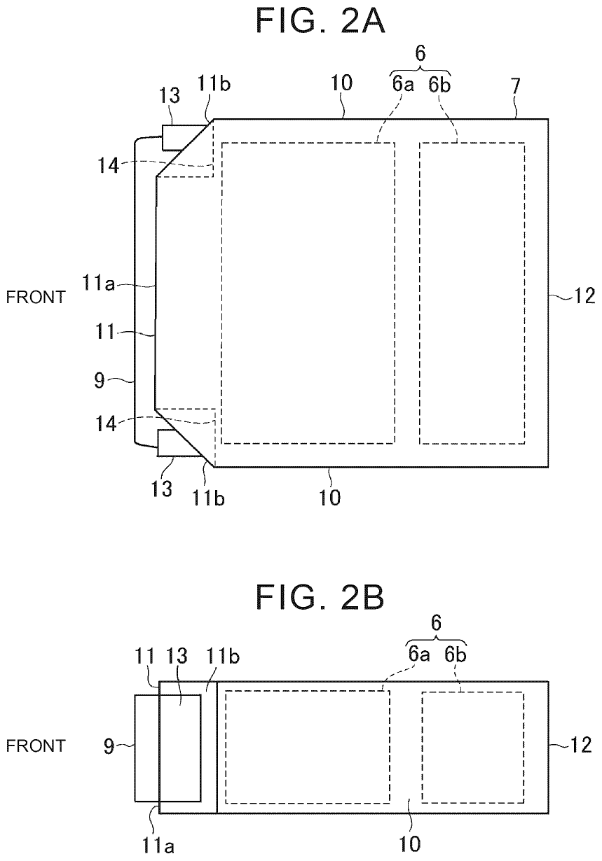

FIGS. 2A and 2B are schematic enlarged views of the PCU case 7. FIG. 2A is a top view of the PCU case 7, and FIG. 2B is a side view of the PCU case 7. As shown in FIGS. 2A and 2B, the PCU case 7 includes side walls 10 on both sides in the vehicle width direction, a front wall 11 on the front side in the direction of travel of the vehicle Ve, and a rear wall 12 on the rear side in the direction of travel of the vehicle Ve.

The front wall 11 has a middle portion 11a that is a middle portion in the vehicle width direction and connecting portions 11b at both ends in the vehicle width direction. The connecting portions 11b are tilted surfaces extending gradually rearward in the direction of travel of the vehicle Ve from the middle portion 11a toward the outside in the vehicle width direction. In other words, the connecting portions 11b are located rearward of the middle portion 11a in the direction of travel of the vehicle Ve. In the following description, the connecting portions 11b will be referred to as tilted surfaces 11b.

The boss 13 protruding toward the front of the vehicle Ve is formed integrally with the tilted surfaces 11b. Specifically, the boss 13 is integrally molded by casting together with PCU case 7.

The distal end face of the boss 13 is located at the same position as, or forward of, the front end face of the PCU case 7 in the vehicle Ve, and the bracket 9 extending in the vehicle width direction is fixed to this distal end face. Specifically, a female screw is formed in the boss 13, and the bracket 9 is fixed to the boss 13 by screwing a bolt, not shown, into the female screw.

The bracket 9 serves to receive a load (impact load) in the event of a collision of the vehicle Ve, and is formed in a rectangular shape so as to cover the front surface of the PCU case 7. That is, the bracket 9 has the same length (height) in the vehicle height direction as the PCU case 7. The bracket 9 is made of a material having relatively high rigidity such as a metal material and its sectional shape (section modulus) is determined such that it has rigidity against a predetermined impact load.

The boss 13 and the bracket 9 are not limited as long as they are integral with the PCU case 7. Therefore, the boss 13 and the PCU case 7 may be separately molded and connected by welding etc., and the PCU case 7, the boss 13, and the bracket 9 may be integrally molded by casting or the like.

Since the bracket 9 is provided forward of the PCU case 7 as described above, the bracket 9 receives an impact load when the vehicle Ve collides with an obstacle etc. ahead. The impact load acting on the bracket 9 is applied to the PCU case 7 via the boss 13. As described above, the boss 13 is connected to the right and left tilted surfaces 11b of the PCU case 7. Therefore, the load applied from the boss 13 to the PCU case 7 can be received by the side walls 10 of the PCU case 7 that have relatively high rigidity against the impact load. This can reduce the load acting on the front surface of the PCU case 7, and therefore, can reduce damage to electrical components such as the inverter 6a and the driver circuit 6b due to deformation of the front surface of the PCU case 7, and exposure of the electrical components due to damage to the PCU case 7 etc. In other words, it is possible to improve the capability to protect the PCU case 7 in the event of a collision of the vehicle Ve.

Since the bracket 9 is provided so as to cover the front surface of the PCU case 7 as described above, the electric components are less likely to be exposed to the outside even if the front surface of the PCU case 7 cracks in the event of a collision of the vehicle Ve.

Moreover, since the boss 13 is connected to the tilted surfaces 11b, the boss 13 is allowed to have a length large enough to attach the bracket 9, and the clearance between the bracket 9 and the front surface of the PCU case 7 is less likely to become excessively large. In other words, even when the clearance between the PCU case 7 and the radiator 8 etc. disposed in front of the PCU case 7 is small, the bracket 9 for protecting the PCU case 7 can be attached.

As described above, the boss 13 may be mounted at any position as long as it is located rearward of the front wall 11 of the PCU case 7 in the direction of travel of the vehicle Ve and it transmits the load to the side walls of the PCU case 7. As shown by dashed lines in FIGS. 2A and 2B, a step portion 14 recessed from the front surface of the PCU case 7 may be formed on the right and left sides of the PCU case 7, and the boss 13 may be fixed to the step portion 14.

The high-voltage module according to the embodiment of the present disclosure is not limited to the high-voltage module provided in the front compartment as described above. The high-voltage module may be provided in a rear compartment, and a bracket may be provided so as to receive an impact load during traveling in reverse. That is, the bracket may be connected to the rear side of the high-voltage module (front side in the direction of travel during traveling in reverse).

The high-voltage module in the embodiment of the present disclosure is also not limited to the power conversion unit provided in fuel cell electric vehicle. The power conversion unit may be provided in a battery electric vehicle, a hybrid electric vehicle, or the like.

What is claimed is:

1. A protective structure for a high-voltage module configured to convert electric power that is transferred between a motor serving as a driving force source for a vehicle and a power supply for the motor, wherein:
the high-voltage module is housed in a case, the case including side walls located on both sides of the case in a vehicle width direction and a front wall located on a front side of the case in a direction of travel of the vehicle;
the front wall includes a middle portion that is a middle portion of the front wall in the vehicle width direction, and connecting portions located at both ends of the front wall in the vehicle width direction;
the connecting portion is located rearward of the middle portion in the direction of travel of the vehicle; and
the protective structure includes a bracket disposed at a predetermined distance forward of the middle portion in the direction of travel of the vehicle, both ends of the bracket in the vehicle width direction being connected to the connecting portions.

2. The protective structure according to claim 1, wherein the connecting portion is a tilted surface that extends gradually rearward in the direction of travel of the vehicle from the middle portion toward outside in the vehicle width direction.

3. The protective structure according to claim 1, wherein the high-voltage module is provided in a front compartment of the vehicle.

4. The protective structure according to claim 1, wherein the bracket has the same height in a vehicle height direction as the case.

5. The protective structure according to claim 1, further comprising a transaxle case that houses a power transmission device configured to transmit torque from the motor to a drive wheel, wherein
the front wall is located forward of a front end of the transaxle case in the direction of travel of the vehicle.
